(19) United States
(12) Patent Application Publication
(10) Pub. No.: US 2009/0219730 A1
(43) Pub. Date: Sep. 3, 2009

(54) ILLUMINATED TRIM ELEMENT FOR AN INSTRUMENT CLUSTER

(75) Inventors: Timothy J. Syfert, Wyoming, MI (US); Scott R. Meyers, Holland, MI (US); Elizabeth A. Pyle, Zeeland, MI (US); Timothy J. Borgeson, Hudsonville, MI (US); Toru Inagaki, Holland, MI (US); Brook R. Burg, Grand Rapids, MI (US); Steve Schultz, Holland, MI (US); Rodger W. Eich, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/063,758

(22) PCT Filed: Aug. 15, 2006
(86) PCT No.: PCT/US06/31873

§ 371 Date: Sep. 2, 2008

Related U.S. Application Data
(60) Provisional application No. 60/708,660, filed on Aug. 16, 2005.

(51) Int. Cl. B60Q 1/00

(52) U.S. Cl. 362/489

(57) ABSTRACT

An instrument cluster for a passenger vehicle may comprise a trim element that may comprise a leading portion nearest a passenger area, a trailing portion furthest from the passenger area, and a light transmissive portion. The instrument cluster may comprise an applique proximate the trailing portion of the trim element and a circuit comprising at least one illumination device. The trim element may be configured so that light is transmitted from the at least one illumination device through the leading portion toward the passenger area when the at least one illumination device emits light.

### FIELD

The present application relates generally to the field of automotive displays, and particularly to instrument clusters and trim elements for vehicles.

### BACKGROUND

Many vehicles include instrument clusters which display various types of information. This information may include instrumentation such as a speedometer, tachometer, fuel level gauge, etc. This information may also include a seat belt indicator, low-fuel warning, a check engine warning, an engine temperature warning, an anti-lock brake indicator, a traction control indicator, tire-pressure warnings, and/or other indicators. This information may further include turn signal indicators.

Many instrument panels and instrument clusters are designed for day and night displays. Accordingly, instrument clusters are often designed to provide readable information during the day and night, utilizing various types of lighting systems. Despite the large number of known lighting systems utilized for instrument panels and instrument clusters, most known systems typically do not provide certain aesthetically pleasing features and characteristics.

Accordingly, it would be advantageous to provide a system and method which provides for an instrument cluster lighted barrel trim ring comprising a leading portion, which faces a vehicle passenger, that may be illuminated and that directs light toward the vehicle passenger and away from the face of the appliqué and/or gauge. It would further be advantageous to provide an instrument cluster lighted barrel trim ring that may comprise light transmissive or diffusive materials that enables the sides of the barrel to be illuminated and/or to transmit light away from the sides of the barrel. It would further be advantageous to provide an instrument cluster lighted barrel trim ring having multiple layers of lights to create an illusion of dimension or depth through the barrel trim ring. It would be desirable to provide a system and method that provides any one or more of these or other advantageous features.

The teachings herein extend to those embodiments which fall within the scope of the appended claims, regardless of whether they address one or more of the above-mentioned problems.

### SUMMARY

According to one embodiment, an instrument cluster for a passenger vehicle comprises a trim element comprising a leading portion nearest a passenger area, a trailing portion furthest from the passenger area, and a light transmissive portion, an appliqué proximate the trailing portion of the trim element, and a circuit comprising at least one illumination device. The trim element is configured so that light is transmitted from the at least one illumination device through the leading portion toward the passenger area when the at least one illumination device emits light.

According to another embodiment, a lighting device for a passenger vehicle comprises an instrument panel comprising a mounting area, an instrument cluster mounted to the instrument panel at the mounting area, the instrument cluster comprising a trim element having a back portion, a leading portion nearest a passenger area, a trailing portion furthest from the passenger area, and at least one light transmissive portion, an appliqué proximate the trailing portion of the trim element, and an illumination device located proximate the back portion of the trim element, the illumination device configured to transmit light through the leading portion toward the passenger area when the illumination device emits light.

### BRIEF DESCRIPTION OF THE DRAWINGS

FIG. 1 is a front perspective view of an instrument cluster according to an exemplary embodiment;

FIG. 2 is a side plan view of an instrument cluster according to an exemplary embodiment;

FIG. 3 is a side plan view of an instrument cluster according to an exemplary embodiment;

FIG. 4 is a side plan view of an instrument cluster according to an exemplary, embodiment;

FIG. 5 is a side plan view of an instrument cluster according to an exemplary embodiment; and

FIG. 6 is a block diagram of a process for forming an instrument cluster according to an exemplary embodiment.

### DETAILED DESCRIPTION

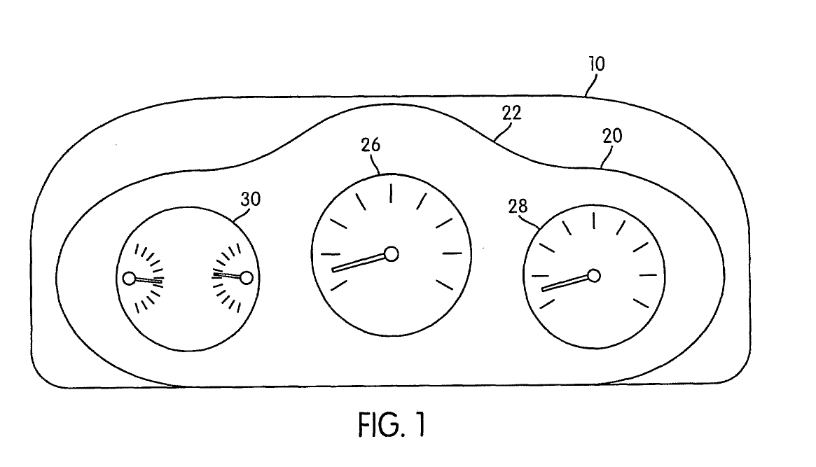

Referring to FIG. 1, an instrument cluster 20 is shown according to an exemplary embodiment. Instrument cluster 20 is an assemblage of parts configured to provide automobile data from a plurality of automobile systems to an operator of the automobile and/or to passengers of the automobile. Instrument cluster 20 comprises a housing 22 configured to be fixedly mounted to an instrument panel 10 of an automobile at one or more locations on instrument panel 10, such as in front of the operator, near the center stack, etc., or even in an overhead compartment coupled to the headliner of the vehicle. Instrument cluster 20 may be coupled to instrument panel 10 at any suitable mounting area. Instrument cluster 20 is suitable for use with an automobile, which can be any passenger vehicle used for land transportation, such as a car, minivan, truck, etc. According to alternative embodiments, the instrument cluster and panel may be used with any type of vehicle, such as water vehicles, air vehicles, etc.

According to an exemplary embodiment, and as best shown in FIG. 1, instrument cluster 20 provides a speedometer display 26, an engine rotations-per-minute (RPM) display 28, and a display 30 configured to display a plurality of automobile data. Automobile data can include speed, engine RPMs, engine oil temperature, fuel remaining, engine oil level, engine water temperature, engine oil pressure, instantaneous consumption, turbo rate, battery level, seat belt indicator, windshield wash level, hazard light indicator, and/or other information. Instrument cluster 20 can include more or less than the displays indicated.

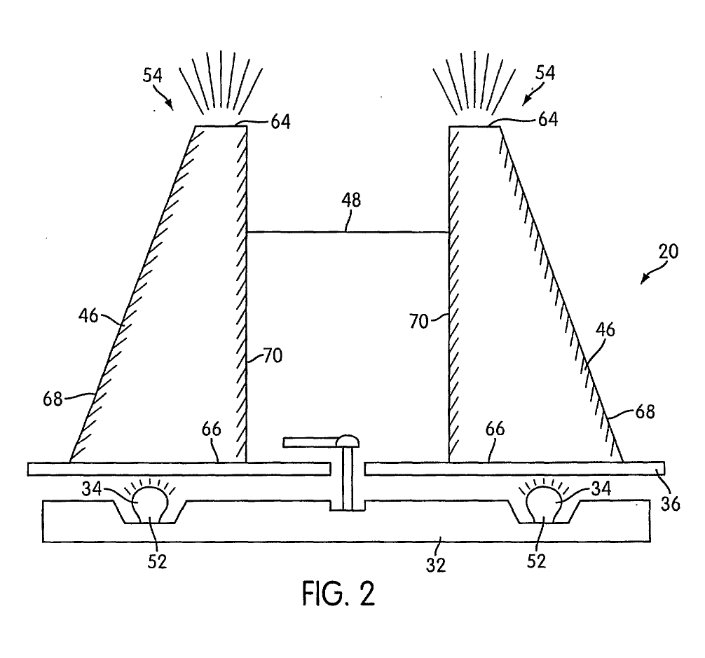

Referring now to FIG. 2, instrument cluster 20 is illustrated in greater detail. Instrument cluster 20 comprises a circuit board 32 (e.g., printed circuit board) having a plurality of illumination devices 52 (e.g., light sources, light emitting diodes, incandescent bulbs, etc.), an appliqué 36 having indicia such as speed and RPM markings, light guides or light pipes (e.g., plastic or other material configured to transmit light) which can be shaped in the form of tick marks (e.g., lines, arrows, circles, etc.), and a trim element 46 (e.g., a bezel, a trim ring, a barrel, tunnel, etc.) having a lens 48 (optional). According to an exemplary embodiment, the circuit board may include a control circuit or be coupled to a control circuit. The control circuit coupled to the circuit board and/or the circuit board comprising the control circuit can comprise one or more analog and/or digital electrical or electronic components, and may include a microprocessor, microcontroller, application-specific integrated circuit (ASIC), programmable logic, and/or other circuit elements. According to an exemplary embodiment, the control circuit is configured to receive data via one or more electrical wires or buses from a plurality of automobile systems within the automobile. For example, the control circuit can be configured to receive fuel data from a fuel level sensor and engine oil temperature data from an engine oil temperature sensor on an automobile. According to various exemplary embodiments, the circuit board may be a printed circuit board, a flexible circuit board, a rigid circuit board, conductive foil, and/or other suitable form.

According to an exemplary embodiment, the plurality of illumination devices 52 comprise light emitting diodes (LEDs) 34 on circuit board 32 which transmit light through appliqué 36 and through trim element 46. Trim element 46 may comprise a plurality of trim rings, tunnels, or barrels 54 (shown as a portion of portion of displays 26, 28, 30 in FIG. 1). Each trim ring 54 may comprise a leading portion 64 (e.g., a leading edge), a trailing portion 66 (e.g., a trailing edge), an outer surface 68, and an inner surface 70. Trim element 46 may be configured so that light emitted from LEDs 34 is transmitted through at least one of leading portion 64, outer surface 68 and inner surface 70 (e.g., leading portion 64, outer surface 68 and inner surface 70 may be light transmissive portions of trim element 46). According to an exemplary embodiment, leading portion 64, outer surface 68 and inner surface 70 may be at least partially translucent to transmit light from LEDs 34 when LEDs 34 emit light. According to an embodiment, the leading portion or edge is proximate a vehicle passenger for viewing by the vehicle passenger. According to an exemplary embodiment, the LED may be positioned between the trim element and the appliqué. According to various exemplary embodiments, providing a trim element closer to a vehicle occupant than an appliqué allows for 3-D effects, interesting trim details, entertainment during a startup or shut down sequence, supplemental indicators or turn signals, etc.

According to an exemplary embodiment shown in FIG. 2, trim element 46 may be configured so that light only passes through leading portion 64. According to an exemplary embodiment, leading portion 64 may comprise a suitable light transmissive material. Outer surfaces 68 and inner surfaces 70 may be configured to block and/or restrict the transmission of light from illumination devices 52 (e.g., LEDs 34). According to an exemplary embodiment, outer surfaces 68 and inner surfaces 70 may comprise a treatment such as a masking paint, film, or foil which may be applied to the surfaces to block light emitted from illumination devices 52 (and thereby produce a light pipe to produce the lighted effect through leading portion 64). According to various alternative embodiments, any other suitable technique may be used to produce the effect of light through the leading portion but not through the outer and inner surfaces of the trim element. According to an exemplary embodiment, leading portion 64 may comprise a metallic or foil appearance. Leading portion 64 can include a treatment comprising a reflective metallic substance or coating to create a bezel-like appearance. The coating enables leading portion 64 to be at least partially translucent in order to reflect light from the occupant area of the vehicle as well as transmit emitted light from LEDs 34 through to the occupant area of the vehicle.

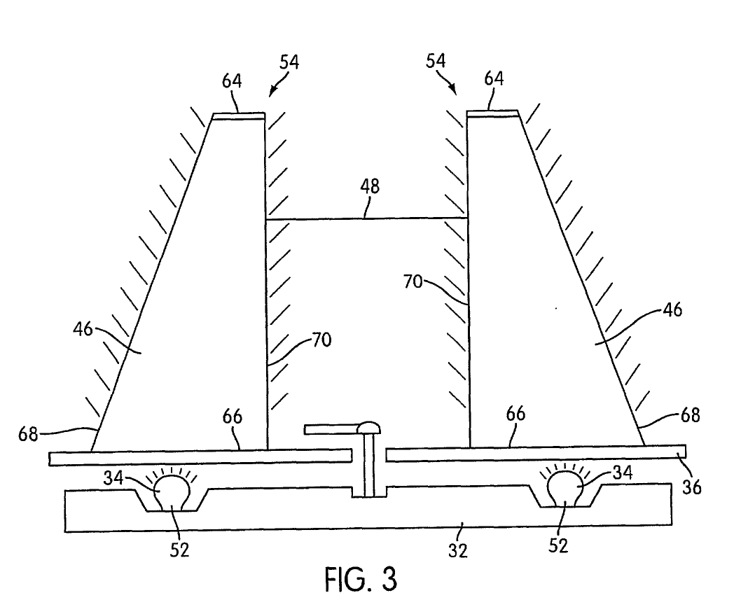

According to an exemplary embodiment shown in FIG. 3, trim element 46 may be configured so that light only passes through at least one of outer surfaces 68 and inner surfaces 70. According to an exemplary embodiment, outer surfaces 68 and inner surfaces 70 may comprise a suitable light transmissive material. Leading portion 64 may be configured to block and/or restrict the transmission of light from illumination devices 52 (e.g., LEDs 34). According to an exemplary embodiment, leading portion 64 may comprise a treatment such as a masking paint, film, or foil which may be applied to the leading portion to block light emitted from illumination devices 52. According to an exemplary embodiment, leading portion 64 may comprise hydrographic or foil metallic material to produce “dead-fronting” or non-illumination along portion 64. Trim element 46 may comprise a material that creates a “glowing effect” therein when illumination devices 52 emit light. For example, trim element 46 may comprise a material that diffuses or scatters light in multiple directions instead of directing all light to a particular location. According to an exemplary embodiment, the trim element material may be at least partially reflective and may scatter light to create the glowing effect. According to, another exemplary embodiment, the trim element may comprise phosphorus that is exited by an ultraviolet LED to produce a glowing effect. According to various alternative embodiments, any other suitable method of creating a glowing effect throughout may be used. According to an exemplary embodiment, trim element 46 may be configured to emit light beyond surfaces 68 and 70. Light may be transmitted from illumination devices 52, through light transmissive surfaces 68 and 70, and to a location beyond surfaces 68 and 70.

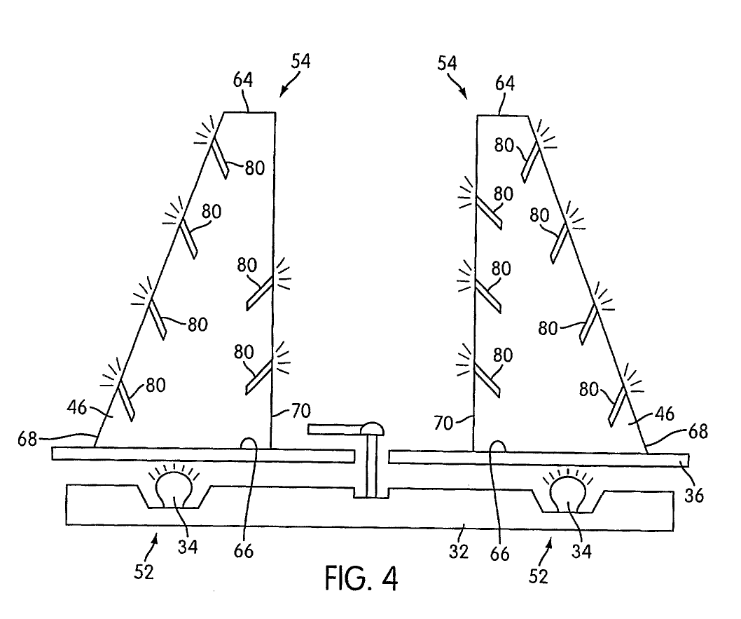

According to an exemplary embodiment shown in FIG. 4, outer surfaces 68 and inner surfaces 70 may be configured to block and/or restrict the transmission of light from illumination devices 52 (e.g., LEDs 34). According to an exemplary embodiment, outer surfaces 68 and inner surfaces 70 may comprise a treatment such as a masking paint, film, or foil which may be applied to the surfaces to block light emitted from illumination devices 52. As shown in FIG. 4, various patterns 80 may be etched into the light blocking materials of surfaces 68 and 70. A flood light or other suitable light may be used to transmit light onto etched patterns 80 or other reflective surface. The etchings may be embedded in a translucent sheet by disrupting the form of the sheet to create visual markings that will result in the outward transmission of light that is piped into the translucent trim element. This may be done by etching the trim element, changing the topography of the trim element, embossing the trim element, tool texturing the trim element, transferring an in-mold graphic to the trim element, foil painting the trim element, changing the crystal structure of the trim element, or by any other suitable technique. According to one embodiment, the etchings or markings are added in a molding step when the trim element is formed. The etchings or markings may be formed in a translucent trim element in three dimensions (e.g., by laser etching a 3-D image in the trim element) such that a resulting image has a three dimensional appearance. The 3-D image may be formed using a technique similar to Crystology 3-D to form 3-D images in various products.

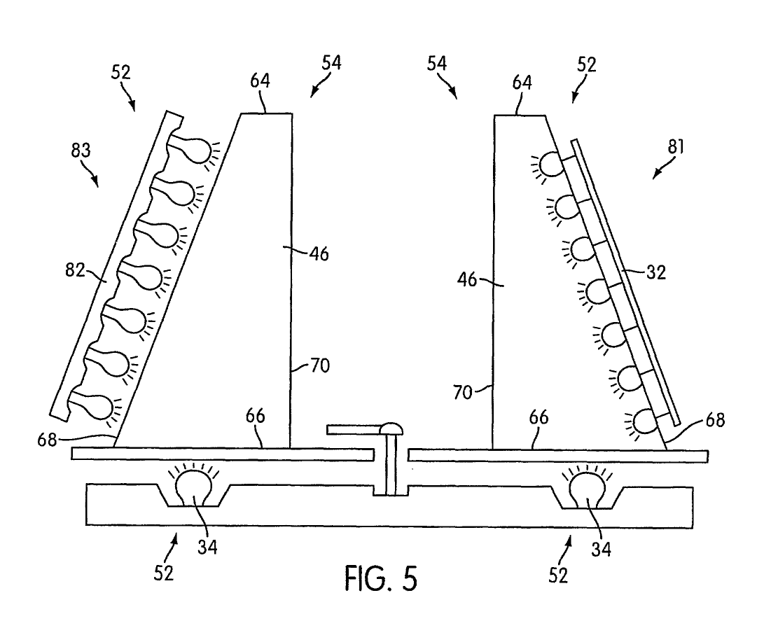

According to an exemplary embodiment shown in FIG. 5, a plurality of illumination devices 52 may be utilized to produce a layered lighting effect along trim element 46. Illumination devices 52 may be coupled to one of surfaces 68, 70, a flange 82, circuit 32, or other structure along trim element 46 between leading portion 64 and trailing portion 66. According to an exemplary embodiment, illumination devices 52 may be configured to be located within a portion of trim element 46 (as shown at portion 81). According to another exemplary embodiment, illumination devices 52 may be configured to be located along an outer portion of trim element 46 (as shown at portion 83). Illumination devices 52 may be configured to emit light in a predetermined sequence along a length of trim element 46 (e.g., between portions 66 and 64) to create an impression of a layered or three-dimensional depth. According to various exemplary embodiments, illumination devices 52 may be configured to emit light according to any suitable sequence or function (e.g., the illumination devices may be configured to light up at vehicle start-up in a sequence, produce a strobe effect, etc.).

According to an exemplary embodiment, any of the light transmissive portions of the trim element may be configured to transmit light in combination with other light transmissive portions according to any suitable configuration. For example, leading portion 64, inner surface 70 and outer surface 68 may be configured to each transmit light from illumination devices 52 at the same time when illumination devices 52 emit light. According to an alternative embodiment, only leading portion 64 may transmit light when illumination devices 52 emit light. According to an alternative embodiment, only surface 68 and/or 70 may transmit light with illumination devices emit light.

According to an exemplary embodiment, illumination devices 52 may be configured to emit light in conjunction with various functions of a vehicle. For example, one or more of illumination devices 52 may be configured to emit light when a vehicle operator utilizes a turn signal (e.g., the leading portion of the left barrel may light up in unison with the left turn signal to further demonstrate to the vehicle operator the signal feature). According to another exemplary embodiment, three barrels may light up in a red or other bright color when a check engine light appears on the vehicle display. The additional lights provide added safety features for a driver to draw attention to a potential problem or provide awareness of a vehicle function. According to various exemplary embodiments, the illumination devices may be any number of suitable colors and may be configured to illuminate in conjunction with any number of vehicle functions (e.g., vehicle start-up, high temperature, low oil, low fuel, turn signals, high speeds, etc.).

According to various exemplary embodiments, the illuminated areas or portions are observable during day and night when LEDs emit light. According to an alternative embodiment, more than one portion (e.g., surface 68, surface 70, leading poriton 64, etc.) may be illuminated by a single illumination device, such as a single LED that illuminates multiple (and/or all) light transmissive portions. According to various exemplary embodiments, the trim element, surfaces, edges or portions, and illuminated portions may be any number of configurations. For example, the etched patterns may be oval, triangular, rectangular, 3-D, 2-D, etc.

When not illuminated, trim element 46 may have a first visual state where it is less noticeable. When illuminated, trim element 46 may have a second visual state where it is more noticeable. The trim element may be switched from the first visual state to the second visual state. Certain portions of the trim element may be configured such that they can be selectively switched from the first visual state to the second visual state at the same time. According to an exemplary embodiment, a light source is utilized such that there is a high contrast between the first visual state and the second visual state for the trim element.

Any number of configurations may be used for the components or parts of the instrument cluster. For example, appliqués, sheets, and light pipes may be planar, non-planar, curved, rectangular, ovular, irregularly shaped, thick, a film, or may take some other suitable form. The parts may be translucent. The parts may be formed from plastic, from a polymer, from glass, acrylic and/or other suitable material. According to an exemplary embodiment, a traditional lens of an instrument cluster can serve as the sheet, which may be formed from a plastic material and may have a substantially planar form. A clear sheet and light pipes would result in transmission of light. The clarity of the sheet and light pipes, the light source brightness, and the various other factors would preferably be selected such that a sufficient amount of light can reach a suitable location to be illuminated, but such that little or no light would be able reach and illuminate other non-suitable locations.

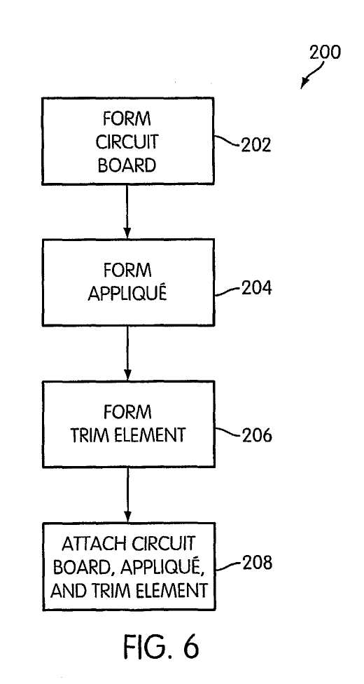

Referring to FIG. 6, a method 100 for forming an instrument cluster is illustrated. The method includes forming a circuit board having a light source at a rear portion of the instrument cluster at block 202, forming an appliqué at block 204, forming a trim element with one or more light transmissive portion at block 206, and attaching the trim element, appliqué and circuit board at block 208. The method may include attaching a trim element carrying indicia and illuminating light pipes, tick marks, indicia, and a rear area of the trim element. Forming the trim element having light transmissive portions may include molding the trim element in a manner configured to carry indicia (e.g. segregating indicia from each other, utilizing a molded score, etching the trim element, changing the topography of the trim element, embossing the trim element, tool texturing the trim element, transferring an in-mold graphic to the trim element, foil painting the trim element, a combination of these steps, or some other step).

Installation of the components at each block may comprise using snap connections, clip connections, adhesives, welding (e.g., sonic, laser, etc.), and/or other suitable means. Illumination from the light sources may include illuminating the light transmissive portions with one or more than one light source. The illumination may be in response to a value of a measured parameter, to a change in a vehicle condition, and/or to user input. The illuminating may be based on ignition of the engine and/or may be in response to a change in state of an accessory (e.g., radio, air conditioning, heat, interior lamp, navigation system, etc.). The trim element may be positioned either on the surface of the instrument panel adjacent to a gauge, on an instrument cluster lens surface, or at any other suitable surface or location.

The construction and arrangement of the elements of the system as shown in the exemplary, preferred and alternative embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of fasteners, connectors, etc. may be reversed or otherwise varied, etc. It should be noted that the elements and/or assemblies of the system may be constructed from any of a wide variety of materials that provide sufficient strength or durability, including any of a wide variety of moldable plastic materials (such as high-impact plastic or plastic having various coatings, such as hard-coating material) in any of a wide variety of colors, textures and combinations. It should also be noted that the system may be used in association with any of a wide variety of types of components and/or features such as digital displays, electronic displays, etc. Accordingly, all such modifications are intended to be included within the scope of the present system. Other substitutions, modifications, changes and omissions may be made in the design, operating conditions and arrangement of the preferred and other exemplary embodiments without departing from the scope of the present system.

What is claimed is:

1. An instrument cluster for a passenger vehicle, comprising:
a trim element comprising a leading portion nearest a passenger area, a trailing portion furthest from the passenger area, and a light transmissive portion;
an appliqué proximate the trailing portion of the trim element; and
a circuit comprising at least one illumination device;
wherein the trim element is configured so that light is transmitted from the at least one illumination device through the leading portion toward the passenger area when the at least one illumination device emits light.

2. The instrument cluster of claim 1, wherein the leading portion comprises the light transmissive portion.

3. The instrument cluster of claim 2, wherein the light transmissive portion is at least partially translucent.

4. The instrument cluster of claim 1, wherein the trim element comprises a trim barrel having sides.

5. The instrument cluster of claim 4, wherein the sides of the trim barrel are configured to transmit light from the at least one illumination device a predetermined distance beyond the sides of the trim barrel.

6. The instrument cluster of claim 4, wherein the trim barrel comprises an at least partially translucent material configured to scatter light from the at least one illumination device.

7. The instrument cluster of claim 4, wherein the trim barrel comprises a non-transmissive portion configured to block light emitted from the at least one illumination device.

8. The instrument cluster of claim 7, wherein the non-transmissive portion comprises an etched portion configured to allow light to be transmitted through the etched portion when the at least one illumination device emits light.

9. The instrument cluster of claim 4, wherein the at least one illumination device comprises a plurality of light emitting diodes positioned between the leading portion and the trailing portion.

10. The instrument cluster of claim 9, wherein the plurality of light emitting diodes are configured to emit light in a predetermined sequence to provide a three-dimensional effect at the trim element.

11. The instrument cluster of claim 1, wherein the at least one illumination device comprises at least one light emitting diode.

12. A lighting device for a passenger vehicle, comprising:
an instrument panel comprising a mounting area;
an instrument cluster mounted to the instrument panel at the mounting area, the instrument cluster comprising a trim element having a back portion, a leading portion nearest a passenger area, a trailing portion furthest from the passenger area, and at least one light transmissive portion;
an appliqué proximate the trailing portion of the trim element; and
an illumination device located proximate the back portion of the trim element, the illumination device configured to transmit light through the leading portion toward the passenger area when the illumination device emits light.

13. The lighting device of claim 12, wherein the leading portion comprises the light transmissive portion.

14. The lighting device of claim 12, wherein the trim element comprises a trim barrel having sides.

15. The lighting device of claim 14, wherein the sides of the trim barrel are configured to transmit light from the at least one illumination device a predetermined distance beyond a surface of the at least one trim barrel.

16. The lighting device of claim 14, wherein the trim barrel comprises an at least partially translucent material configured to scatter light from the at least one illumination device.

17. The lighting device of claim 14, wherein the trim barrel comprises a non-transmissive portion configured to block light emitted from the at least one illumination device.

18. The lighting device of claim 17, wherein the non-transmissive portion comprises an etched portion configured to allow light to be transmitted through the etched portion when the at least one illumination device emits light.

19. The lighting device of claim 14, wherein the at least one illumination device comprises a plurality of light emitting diodes positioned between the leading portion and the trailing portion.

20. The lighting device of claim 19, wherein the plurality of light emitting diodes are configured to emit light in a predetermined sequence to provide a three-dimensional effect at the trim element.
